(19) United States
(12) Patent Application Publication
(10) Pub. No.: US 2022/0282895 A1
(43) Pub. Date: Sep. 8, 2022

(54) A METHOD AND AN APPARATUS FOR AT LEAST PARTIALLY DRAINING AN OPERATING SYSTEM

(71) Applicant: Mexichem Fluor S.A. de C.V., San Luis Potosi (MX)

(72) Inventor: Robert Low, Runcorn (GB)

(21) Appl. No.: 17/630,245

(22) PCT Filed: Jul. 27, 2020
(86) PCT No.: PCT/GB2020/051798

§ 371 Date: Jan. 26, 2022

(30) Foreign Application Priority Data
Jul. 30, 2019 (GB) 1910839.8

(51) Int. Cl. F25B 45/00; F25B 9/00

(52) U.S. Cl. CPC F25B 45/00; F25B 9/008; F25B 2345/002

(57) ABSTRACT

A method for at least partially draining an operating system, which contains a working fluid (comprising carbon dioxide (R744) and a halogenated hydrocarbon). The method comprises transferring the working fluid to a target container, from the operating system, wherein the working fluid is contacted with an absorptive bed.

The present invention relates to a method for at least partially draining an operating system, which contains a working fluid.

Refrigeration systems are commonplace. Examples of refrigeration systems include refrigerated storage containers, as may be found in supermarkets, for containing foodstuffs or other materials, which need to be kept in a cooled/frozen state, to prevent/delay spoiling before sale.

Such refrigeration systems typically comprise a working fluid, which, in conjunction with a refrigeration/air conditioning unit, provides the desired cooling effect. The working fluids typically comprise hydrocarbons, carbon dioxide, ammonia and halogenated (chloro- and/or fluoro-) hydrocarbons. Often the working fluid comprises a mixture of two of more agents.

There are occasions when the working fluid has to be removed from the refrigeration system. Such removal may be occasioned by normal servicing, wherein the fluid has to be replaced; either following a scheduled servicing regime or due to degradation of the fluid with use. Other reasons for removal arise when the refrigeration system is being taken out of service.

Since many of the working fluids are potentially harmful for one or more issues including; toxicity, flammability and issues with global warming/ozone depletion there is a need for the fluid to be safely removed; both to ensure the safety of the removal operator and the prevention of discharge of potentially harmful chemicals into the atmosphere. Safe removal of the working fluid and transfer of same to a storage vessel achieve these aims. Further such removal is useful in that working fluid can be reused after removal, such as in a second refrigeration system.

Conventional recovery equipment for halocarbon refrigerants operates by a combination of liquid recovery followed by vapour recovery.

For the liquid recovery stage, the refrigerant is removed from the system as a liquid and transferred into a storage vessel.

For the vapour recovery stage, vapour is pumped out of the system then compressed and condensed in a small condenser heat exchanger, forming part of the recovery apparatus. The condensed refrigerant is then returned to a recovery cylinder for re-use or disposal. The condenser may be cooled by ambient air or a small onboard refrigeration loop in the recovery unit may be used. The compressor of the refrigeration system may be used to assist this pump-down process, or the vapour can be extracted and then compressed by a dedicated compressor forming part of the recovery unit.

Removal of the working fluid is made more complex when the working fluid comprises a mixture of two of more agents. The complexity arises since at the time of removal the specification of the working fluid has typically been altered from when it was applied meaning that reuse is not straightforward. Additionally, there may be a desire for reuse of certain components of the working fluid, rather than the admixture, requiring separation of the working fluid. These complications may lead to improper working fluid discharge, rather than the addressing of the issues. This is a particular issue when one of the components of the admixture comprises a halogenated hydrocarbon, the release of which into the atmosphere is highly regulated and one of the components of the admixture comprises an agent, for which the release of which into the atmosphere is less/un-regulated (such as carbon dioxide).

It is an object of the present invention to obviate or mitigate the issues described above.

According to a first aspect of the invention there is provided a method for at least partially draining an operating system, which contains a working fluid (comprising carbon dioxide (R744) and a halogenated hydrocarbon), the method comprising transferring the working fluid from the operating system to a target container, wherein the working fluid is contacted with an absorptive bed.

The method of the invention has been found to be surprisingly effective in the removal of working fluids comprising an admixture of carbon dioxide (R744) and a halogenated hydrocarbon. Using the method of the invention it is possible to at least recover the halogenated component of the admixture for re-use or disposal.

Generally, the operating system comprises a vapour-compression cycle for air-conditioning, heat pumping or refrigeration. A preferred example of such a system is a medium-temperature refrigeration system. Hence the preferred working fluid comprises a refrigerant.

The working fluid may be contacted with the absorptive bed more than once.

In the method the composition may be contacted with two or more absorptive beds. In such case the beds may be the same or different. Where the beds are different one bed may be for absorption of the halogenated hydrocarbon and a second bed may be for the absorption of the carbon dioxide.

Generally, the contacting step is performed, at least in part, at a temperature of from about 0° C. to about 200° C., more preferably at a temperature of from about 20° C. to about 100° C., more preferably at a temperature from about 20° C. to about 60° C., preferably at a temperature of about 40° C.

Generally, the contacting step is conducted at a pressure of from about 0.1 to 50 Bara.

The absorptive bed may require treatment prior to the contacting step. The treatment step preferably comprises a heat treatment step comprising heating the bed so as to remove adsorbed gases, optionally followed by a cooling step to reduce the temperature of the solid adsorptive material and thus improve its capacity for uptake of fluid.

The absorptive bed treatment step may comprise an exposure step comprising exposing the adsorbent to one or more inert gases, preferably N₂ or one or more noble gases.

The absorptive bed treatment step (prior to the contacting step) may be operated under a full/partial vacuum.

The absorptive bed may be dried before use.

The absorptive bed may require treatment after the contacting step. It will be appreciated that the absorptive material may need treatment following the use of the apparatus in draining an operating system. Such treatment may be necessitated to regenerate the absorptive material and extract the absorbed material therefrom.

The regeneration of the absorptive material may comprise exposing the absorptive material to elevated temperature and/or reduced pressure or vacuum. In this regeneration preferably the released material is captured.

The method of the invention is suitable for liquid and/or vapour recovery.

Generally, the working fluid comprises a halogenated refrigerant, comprising at least R-32 (difluoromethane). Preferably the working fluid has the composition comprising: (a) from about 10 percent to about 35 percent by weight of R-32; (b) from about 65 percent to about 90 percent by weight of R744 (carbon dioxide), based on the weight of components (a) to (b).

Optionally the halogenated refrigerant fluid comprises amounts of other refrigerants, such as R-1132a (1,1-difluoroethene), R-1123 (trifluoroethene), R-134a (1,1,1,2-tetrafluoroethane), R-152a (1,1-difluoroethane), R-125 (pentafluoroethane), R-227ea (1,1,1,2,3,3,3-heptafluoropropane), R-1234ze(E) (trans-1,1,1,3-tetrafluoropropene), R-1234yf (2,3,3,3-tetrafluoropropene), R-13I1 (iodotrifluoromethane) or mixtures of one or more of these. Preferably the total proportion of halogenated refrigerant in the mixture is about 10 to 35% by weight of the total composition.

The refrigerant may also comprise minor quantities of one or more hydrocarbons selected from: propane (R-290); propene (R-1270); isobutane (R-600a); or n-butane (R-600), wherein the proportion of hydrocarbon in the total mixture is less than about 5% by weight.

According to a second aspect of the invention there is provided an apparatus for at least partially draining an operating system, which contains a working fluid (comprising carbon dioxide (R744) and a halogenated hydrocarbon), wherein the apparatus is suitable for connection with the operating system via a conduit, the apparatus comprising
a) An absorptive bed, and
b) A storage container.

It will be appreciated that features of the first aspect of the invention shall be taken to apply mutatis mutandis to the second aspect of the invention.

Preferably the absorptive bed is upstream of the storage container.

Preferably the absorptive bed comprises an absorptive material. Generally, the absorptive material comprises openings which have a size across their largest dimension of from about 2 Å to about 12 Å.

Generally, the absorptive material comprises an aluminium-containing adsorbent, activated carbon, or a mixture thereof. Preferably the absorptive material comprises alumina or aluminosilicate; most preferably the absorptive material comprises aluminosilicate.

Preferably the aluminosilicate comprises a molecular sieve (zeolite) having pore sizes in the range 2 to 12 Angstroms, e.g. about 3 Å to about 6 Å, such as having a mean pore size of about 3 Å or about 4 Å.

According to a third aspect of the invention there is provided the use of an apparatus according to the second aspect of the invention in performing a method according to the first aspect of the invention.

1. A method for at least partially draining an operating system, which contains a working fluid (comprising carbon dioxide (R744) and a halogenated hydrocarbon), the method comprising transferring the working fluid from the operating system to a target container, wherein the working fluid is contacted with an absorptive bed.

2. The method of claim 1, wherein the operating system is a refrigeration system.

3. The method according to claim 1, wherein the operating system is a medium-temperature refrigeration system.

4. The method according to claim 1, wherein the fluid is contacted with the absorptive bed more than once.

5. The method according to claim 1, wherein the fluid is contacted with two or more absorptive beds.

6. The method according to claim 1, wherein the contacting step is performed, at least in part, at a temperature of from about 0° C. to about 200° C.

7. The method according to claim 1, wherein the contacting step is conducted at a pressure of from about 0.1 to 50 Bara.

8. The method according to claim 1, comprising an absorptive bed treatment step prior to the contacting step.

9. The method according to claim 8 wherein the absorptive bed treatment step comprises a heat treatment step comprising heating the adsorbent to a maximum temperature of at least 150° C., preferably at least 200° C.

10. The method according to claim 9 wherein the heat treatment step comprises heating the adsorbent to the maximum temperature at a rate of from 0° C./minute to 60° C./minute, preferably at a rate of from 20° C./minute to 40° C./minute.

11. The method according to claim 9 wherein the heat treatment step comprises maintaining the absorptive bed at or around the maximum temperature for a time of from 1 second to 1 hour.

12. The method according to claim 8, wherein absorptive bed treatment step comprises an exposure step, comprising exposing the absorptive bed to one or more inert gases, preferably N₂ or a noble gas.

13. The method according to claim 8, wherein the absorptive bed treatment step comprises an exposure step comprising exposing the adsorbent to vacuum.

14. The method according to claim 1, comprising an absorptive bed treatment step after the contacting step.

15. The method according to claim 14 wherein the absorptive bed treatment step after the contacting step comprise exposing the absorptive material to elevated temperature and/or vacuum.

16. The method according to claim 1, wherein the working fluid comprises R-32 (difluoromethane).

17. The method according to claim 16, wherein the working fluid comprises: (a) from about 10 percent to about 35 percent by weight of R-32; (b) from about 65 percent to about 90 percent by weight of R744 (carbon dioxide), based on the weight of components (a) to (b).

18. An apparatus for at least partially draining an operating system, which contains a working fluid (comprising carbon dioxide (R744) and a halogenated hydrocarbon), wherein the apparatus is suitable for connection with the operating system via a conduit, the apparatus comprising
a) An absorptive bed, and
b) A storage container.

19. An apparatus according to claim 18 wherein the absorptive bed comprises an absorptive material.

20. An apparatus according to claim 19 wherein the absorptive material comprises openings which have a size across their largest dimension of from about 2 Å to about 12 Å.

21. An apparatus according to claim 19 wherein the absorptive material comprises an aluminium-containing adsorbent, activated carbon, or a mixture thereof.

22. An apparatus according to claim 21 wherein the absorptive material comprises a molecular sieve (zeolite) having pore sizes in the range 2 to 12 Angstroms, e.g. about 3 Å to about 6 Å.

23. A method for at least partially draining an operating system, which contains a working fluid (comprising carbon dioxide (R744) and a halogenated hydrocarbon), comprising connecting the operating system via a conduit to an apparatus according to claim 18.

24. The method according to claim 1, comprising connecting the operating system via a conduit with an apparatus comprising the absorptive bed and the target container.
